(19) United States
(12) Patent Application Publication
(10) Pub. No.: US 2003/0212536 A1
(43) Pub. Date: Nov. 13, 2003

(54) Interactive real-scene tour simulation system and method of the same

(76) Inventors: Cher Wang, Taipei (TW); Parkson Kuo, Taipei (TW)

Correspondence Address: Raymond Sun, 12420 Woodhall Way, Tustin, CA, 92782, US

(21) Appl. No.: 10/373,208

(22) Filed: Feb. 24, 2003

(30) Foreign Application Priority Data
May 8, 2002 (TW) 91109953

(51) Int. Cl. G06G 7/48

(52) U.S. Cl. 703/6

(57) ABSTRACT

The present invention relates to an interactive real-scene tour simulation system and method of the same. As illustrated in the preferred embodiment of the present invention, the user could select a tour location (tour destination) from the Geographic Information System (GIS) or from an expert system and set up the parameters for the tour such as the traveling speed and the tour time. The interactive real-scene tour simulation system and method of the present invention will load in the environmental parameters based on the selected tour location, simulate the real scene of the tour according to the environmental parameters and present the simulation result to the user. When the user starts moving, the system and method of the present invention will detect the user's movement and further calculate the parameters of the user moving direction, moving distance and the user's force applied on the movement. Next, the interactive real-scene tour simulation system and method of the present invention will obtain the environmental parameters based on the user's movement parameters in real-time, simulate the environmental scenario in a real time manner and present the simulation result to the user.

### BACKGROUND OF THE INVENTION

(a). Field of the Invention

The present invention relates to a real-scene tour simulation system and method of the same. Especially, the present invention relates to an interactive real-scene tour simulation system and method that simulate real outdoor scenes interiorly.

(b). Description of the Prior Arts

As technology advancing rapidly day by day, people are getting tense in daily life. In order to catch up the working pace, modern people need to spend much more time on job and in learning. Therefore, in the spare time, they normally do not have too much time and energy for outdoor activities. Meanwhile, local popular tourist spots are always crowded with people during weekends and holiday periods, and an international tour trip needs longer time for arrangement. That is why, in holiday, many people prefer staying at home reading books and magazines, browsing the Internet or playing computer games rather than going outdoor. Obviously, people living in the modern age even have better material life, while the quality of life is really awful.

Also, because of the sophisticated communication technology, a global village is forming; many businessmen are traveling around the world everyday. However, the purpose of their trip is limited to business; they only can take a brief look at the tourist spots during the breaks of their business trips. But for the constrains of time, their sightseeing is just only a passing glance at things, and photos might be taken for memorial if there is a chance. Moreover, it is unlikely to visit the same place again, not under a business trip, even the place is worth visiting for many times, which is quite a pity.

### SUMMARY OF THE INVENTION

The primary aspect of the present invention is to provide an interactive real-scene tour simulation system and method, which perform the simulation of the real outdoor scenes interiorly and, based on the user's movement, simulate the changes of the environment and present the changes back to the user to make the user feel like taking a real tour in the real world.

In a preferred embodiment of the present invention, the user first selects a tour location (tour destination) from a tour location display system. Next, the interactive real-scene tour simulation system and method of the present invention will then load in environmental parameters based on the selected tour location, simulate the real scene of the tour based on the environmental parameters of the terrain, the atmospheric temperature, the sunshine intensity and the environment sound effect associated with the selected tour location and present the simulation result to the user. When the user starts moving, the system and method of the present invention will detect the user's movement and further calculate the parameters of the user's moving direction, moving distance and the force applied on the movement. Next, the interactive real-scene tour simulation system and method of the present invention will again obtain the environmental parameters, but in real-time, based on the user's movement parameters. Finally, the system and method of the present invention will simulate the environmental scenario in a real time manner and present the simulation result to the user. The interactive real-scene tour simulation system of the present invention comprises an activity system; a display device used to display images to the user; an audio system used to create the environmental sound effect of the tour location; a control unit used to control the operation of the interactive real-scene simulation system; an air conditioning system used to create the airflow effect of the tour location; a controlled light source used to control the brightness of light at the tour location and an input device providing the user a function to input the tour location, the tour pace and the tour timeframe. The activity system will input the user's movement parameters into the control unit. The control unit will obtain the environmental parameters of the terrain, the atmospheric temperature, the sunshine intensity and the environment sound effect based on the user's movement parameters associated with the selected tour location and output the calculated simulation results to the display device, the audio system, the air conditioning system and the controlled light source eventually. The aforesaid control unit can be built with an Application Specific Integrated Circuit (ASIC) and embedded in the interactive real-scene tour simulation system to execute the program code used to control the interactive real-scene tour simulation system

In the preferred embodiment of the present invention, the user sets up the tour activity parameters according to the activity he wants to perform, such as jogging, walking and even lying down, and the activity system will simulate the scenario based on the activity parameters. Moreover, the activity system in the preferred embodiment of the present invention could be built with sport exercise equipments like treadmill or sport bike, and the tour location display system could be an interactive system like a geographic information system or an expert system.

### BRIEF DESCRIPTION OF THE DRAWINGS

FIG. 1A to FIG. 1D show the diagrams of an example on how an user selects a tour location via the geographical information system.

FIG. 2 shows a preferred embodiment of the present invention where an user takes tours on an activity platform.

FIG. 3 shows a block diagram of an interactive real-scene tour simulation system of the present invention.

FIG. 4 shows the diagram of an operational flow chart of the interactive real-scene tour simulation system of the present invention.

FIG. 5A to FIG. 5B show the diagrams of an user walking on a simulated slope and stepping on a simulated stone and pit hole.

FIG. 6A to FIG. 6B show the diagrams of how the interactive real-scene tour simulation system of the present invention calculates an user's movement.

### DETAILED DESCRIPTION OF THE PRESENT INVENTION

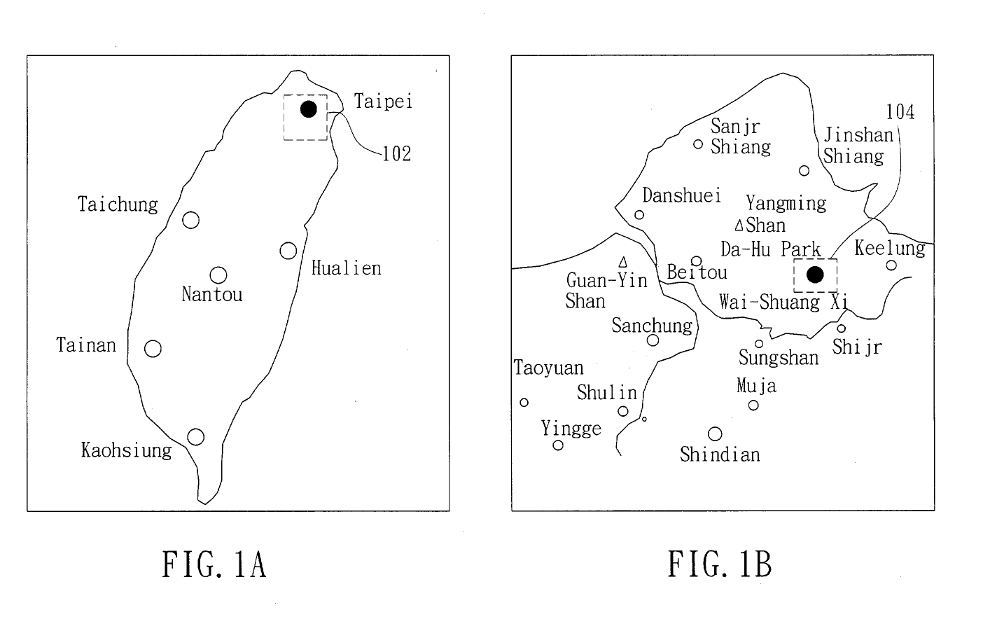

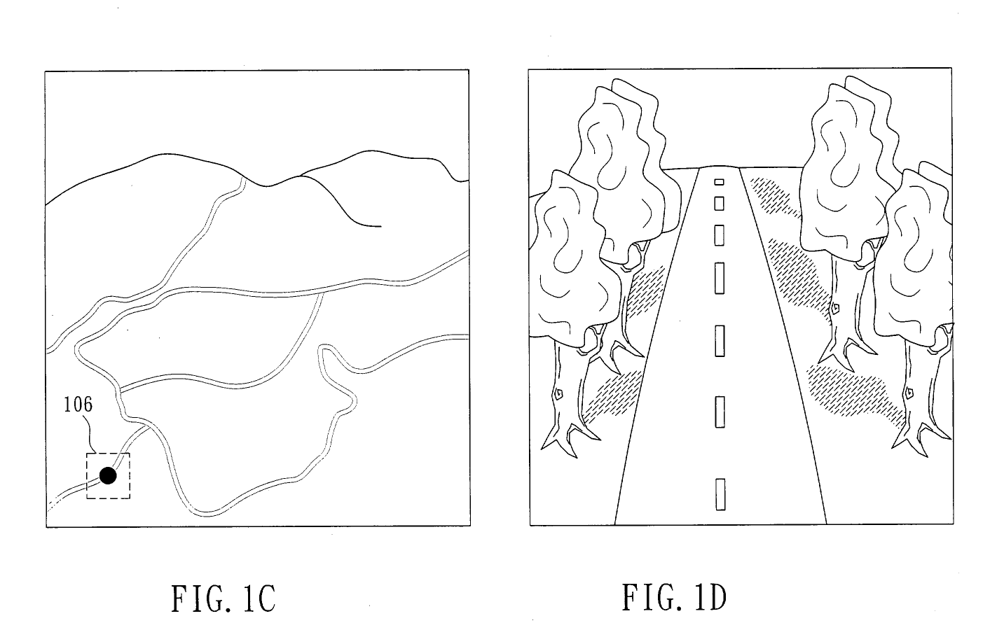

Please refer to FIG. 1A to FIG. 1D, FIG. 1A to FIG. 1D show the diagrams of an example on how an user selects a tour location via a geographic information system (GIS). The tour locations shown in FIG. 1A to FIG. 1D include holiday resorts, the historical interests and hot tourist spots in Taiwan. In fact, the preferred embodiments of the present invention cover any country as well as any place in the universe via the geographic information system. For example, the geographic information system can provide the world map (or can be the map of the Moon, the Solar System or the Universe) for selection, and an user can select any country on the world map for tour, thus making the user feel like taking a real outdoor tour while having an indoor activity.

First, the user can select a city on the map of Taiwan, as shown in FIG. 1A, by using a cursor 102, say selecting Taipei as the city to visit. The geographic information system therefore displays the map of Taipei as shown in FIG. 1B to the user and the user uses a cursor 104 to select a tour location, and as shown, the tour location is Da-Hu Park. The geographic information system further displays the scene of Da-Hu Park to the user via FIG. 1C, and the user uses a cursor 106 to select the starting point at the chosen tour location to begin the tour. Finally, the interactive real-scene tour simulation system of the present invention displays the scene of the starting point of the tour via FIG. 1D and simulates the environmental scene at the starting point and presents to the user. One important thing is that the user almost can select any location for tour, however, in reality, some geographical environments can never be realized, at least not with the current technologies. For example, if the user selects the “cloud” in the sky as the tour location, the tour will be an impossible one because of the limitation of the technology. In another case, unless the user selects a transportation tool (such as a boat) first, he/she will not be able to “walk” in a river. In one preferred embodiment, the system of the present invention will determine if the tour can be taken or not based on the location selected by the user. If the tour cannot be taken in a reasonable way, the system will automatically select a possible tour location for the user; or via Virtual Reality (VR) technology, to simulate and present the simulation result to the user. For example, if the user selects a tour traveling in a river, the system will display a scene just like the user is taking the tour riding in a boat. Various possible modifications, omissions, and alterations could be conceived of by persons skilled in the art to the form and the content of any particular embodiment described above, without departing from the scope of the present invention.

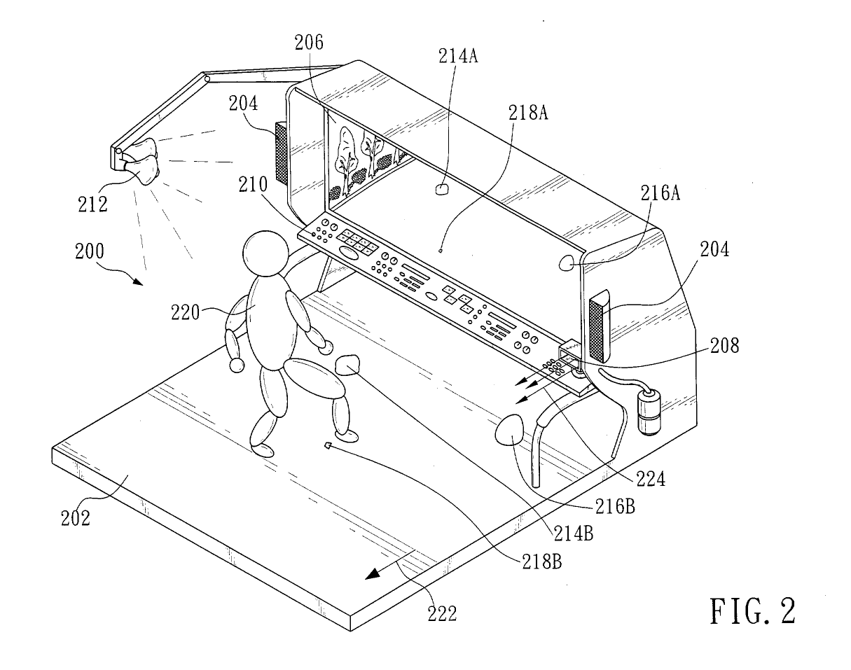

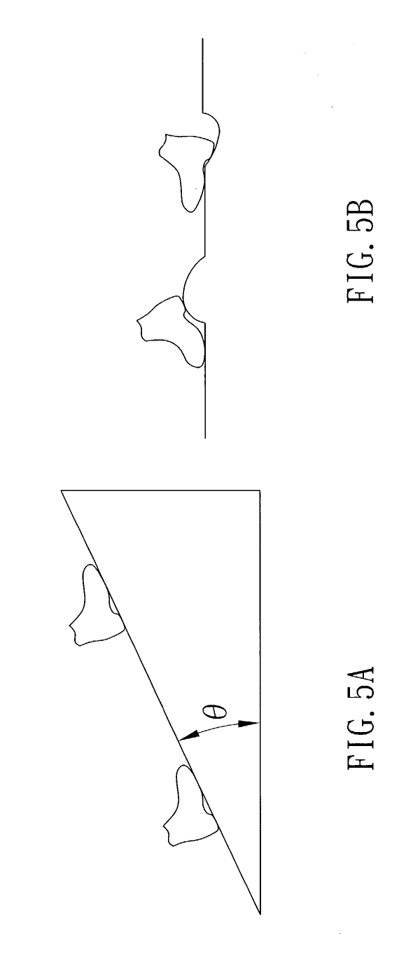

FIG. 2 shows a diagram that the user takes a tour with the interactive real-scene tour simulation system 200 of the present invention. As shown in the figure, the interactive real-scene tour simulation system of the present invention comprises an activity platform 202, a speaker 204, a display screen 206, an air conditioning device 208, a keyboard 210, a controlled light source 212 and the activity platform 202 on which an user 220 is performing. When the user uses the interactive real-scene tour simulation system 200 for taking a tour, he can use the keyboard 210 to select a tour location, and the operational flow is shown in FIG. 1A to FIG. 1D. Once the tour location has been selected, the scene of that tour location will be displayed to the user 220 via the display screen 206, the condition of the temperature and the sunshine at the chosen tour location will be simulated by the air conditioning device 208 and the controlled light source 212 respectively, and the simulation result will be presented to the user. Moreover, the geographical environment condition is simulated and presented by the activity platform 202. For example, when the user is walking up a slope like in FIG. 5A, the activity platform 202 will calculate the related variables, such as the degree of inclination θ, and simulate the geographical environment condition based on the slope of the road, which makes the user apply more energy to walk on the road being simulated by the activity platform 202. In another example, if the scene selected by the user has a big stone 214A, a small stone 218A and a pit 216A on the road, the system will generate the situation and present on the activity platform 202, as what is illustrated in FIG. 5B, and thus making the user feel like walking on the road with all the stones and pits. To simulate that scenario, the interactive real-scene tour simulation system 200 will send out an associated signal, and the activity platform 202 will simulate accordingly. When the user 220 enters the tour location being simulated, the activity platform 202 will present extruding objects 214B, 218B and a pit hole 216B corresponding to the stones 214A, 218A (the big stone and the small stone respectively) and the pit 216A. So, when the user 220 steps on the extruding objects 214B and 218B, which will make the user 220 feel like stepping on the stones 214A and 218A, in the same manner, when the user 220 steps on the pit hole 216B, that makes the user feel like stepping on the pit 216A. In another example, when the user is moving faster (the moving direction of the activity platform 202 is represented by an arrow 222), the air conditioning device 208 will increase the speed of the wind blow (the wind blow direction of the air conditioning device 208 is represented by an arrow 224) that makes the user having the feeling of taking a real tour. In matter of fact, when the user starts the tour activity (such as walking or jogging), the controlled light source 212 will change the brightness of light according to the shadow of trees or mountains on both sides of the road. Besides, even the user is not on the activity platform 202, the interactive real-scene tour simulation system 200 of the present invention can still simulate the real scene of any tour location and present to the user. Certainly, for some tour spots like beaches in Hawaii, the user can lie on the activity platform 202 and the system will simulate the scenario of a beach, the speaker 204 will create the sound effect just like ocean waves tapping on the beach, the display screen 206 will show clouds in the blue sky, the air conditioning device 208 will create a warm breeze from the beach and the controlled light source 212 will illustrate the sunshine of Hawaii. More importantly, the activity platform 202 in FIG. 2 can be any popular sport exercise equipment such as a treadmill or a bike. Of course, some other video game systems such as the car racing game platform can be built in the interactive real-scene tour simulation system 200. Moreover, the quantity and the arrangement of the speakers, the air conditioning device 208 and the controlled light source 212 will not be limited as shown in the FIG. 2, any modification can be made by any person skilled in the art based on the described embodiment without departing from the scope of the present invention.

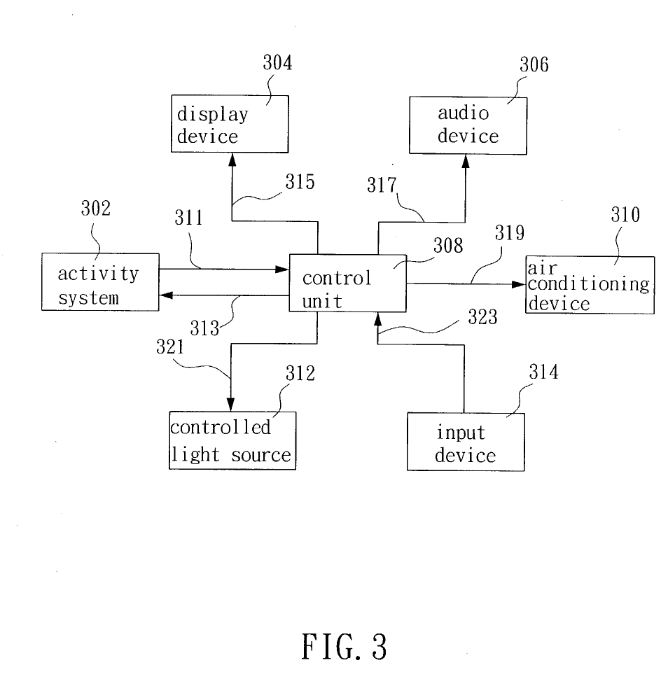

Please refer to FIG. 3, which shows a block diagram of the interactive real-scene tour simulation system of the present invention. Wherein the interactive real-scene tour simulation system comprises an activity system 302 (including an activity platform 202 of FIG. 2) provided to the user for performing activities at; a display device 304 (including a display screen 206 of FIG. 2) used to display the scene to the user; an audio device 306 (such as the speaker 204 of FIG. 2) used to broadcast the audio signal of the environment at the tour location; a control unit 308 used to control the operation of the interactive real-scene tour simulation system; an air conditioning device 310 (such as the air conditioning device 208 of FIG. 2) used to generate the wind blow at the tour location; a controlled light source 312 (such as the controlled light source 212 of FIG. 2) used to adjust the brightness of light according to the tour location; an input device 314 (it could be the keyboard 210 of FIG. 2) with which the user input the tour information such as the tour location, the activity pace and the tour time. After the user selects the tour location and inputs the tour parameters through the input device 314, the relevant instructions and parameters will be inputted (along with the route 323) to the control unit 308. Then, the control unit 308 transfers the control signal to the activity system 302, the display device 304, the audio device 306, the air conditioning device 310 and the controlled light source 312 via the routes 313, 315, 317, 319 and 321 to simulate the real scene of the tour location. Meanwhile, activities that the user perform on the activity system 302 will be transferred to the control unit 308 via the route 311. After the user starts the tour, the control unit 308 will start the simulation according to the tour parameters set up by the user and the simulation result will be further sent to the activity system 302, the display device 304, the audio device 306, the air conditioning device 310 and the controlled light source 312.

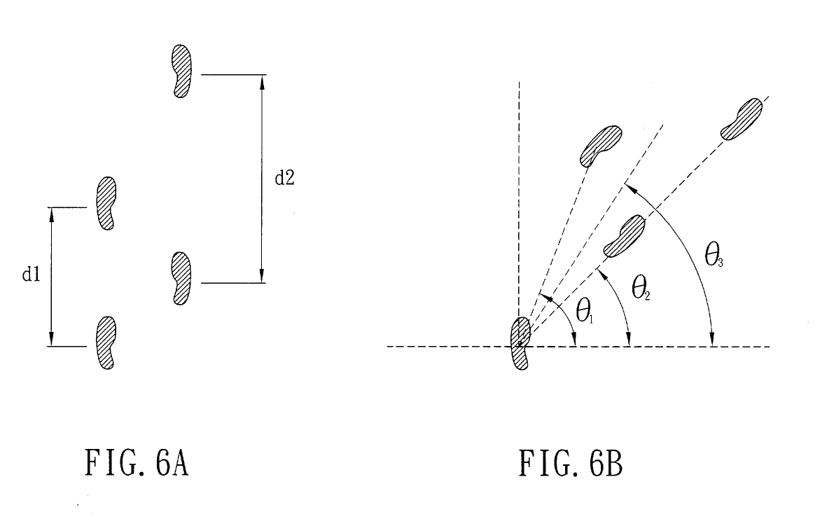

When the user starts the tour on the activity system 302, the activity system 302 will input the parameters of the user's movement into the control unit 308 via route 311. The control unit 308 will obtain the environmental parameters of the terrain, the atmospheric temperature, the sunshine intensity and the environment sound effect associated with the selected tour location based on the parameters of the user's movement and transfer; after certain calculations, the associated simulation result is then output to the display device 304, the audio device 306, the air conditioning device 310 and the controlled light source 312 to present to the user in real-time. For example, when the user is speeding up linearly (almost in a straight line), his/her foot step expands as shown in FIG. 6A. Generally, the user is taking the tour with his/her right and left feet stepping on the activity platform 202 alternately, therefore, the activity platform 202 detects the footprints of the right/left foot having a distance apart. In FIG. 6A, d2 is the distance between two consecutive footprints of the right foot, which is greater than the distance dl of the two consecutive footprints of the left foot, the activity platform 202 detects the situation and transfers the message to the control unit 308. The control unit 308 will calculate and obtain the environment parameters of the tour location according to the movement parameters (in this case, the user is only speeding up linearly), and change the display speed of image, the wind speed, the intensity of sunshine and the environmental sound effect in real time, which makes the user feel the change of the image displaying on the display device 304 and the change of the wind blowing from the air conditioning device 310. In addition, when the user is making a turn, the direction of his steps will change. FIG. 6B is illustrating that the user is making a right turn on the activity platform 202. Since the user is taking the tour with his right and left feet stepping on the activity platform 202 alternately, there is an angle θ1 between the two consecutive footprints of the left foot and the horizontal direction, which is greater than an angle θ2 between the two consecutive footprints of the right foot and the horizontal direction. Another angle θ3 can thus be obtained in between the angle θ1 and the angle θ2, and which can be regarded as the moving direction of the center of gravity of the user who is making a right turn. The control unit 308 will calculate and obtain the environment parameters at the tour location according to the moving direction of the center of gravity, and change the display speed of the image, the wind speed, the intensity of sunshine and the environmental sound effect in real time, which makes the user feel the change of the image displaying on the display device 304 and the change of the wind blowing from the air conditioning device 310. More importantly, the embodiment described above is just an example but is not a limitation; any skilled person can make the possible modification without departing from scope and the spirit of the present invention. For example; when the system calculates the speed that the user is speeding up, only the range of the steps of one foot is put into the consideration and the calculation can incorporate the tolerance, which means the system will not change the speed of the image displaying and the speed of the wind blowing until the difference reaches a certain predetermined value. More, when the user increases (or decreases) the moving speed, the force applying on his two legs is different, and which can be the factor to calculate the acceleration of the user. In the same manner, when the user is making a turn, the moving angle of one foot incorporated with the tolerance can be put into consideration to calculate the environment parameters. Of course, any skilled person can make the possible modification without departing from scope and the spirit of the present invention.

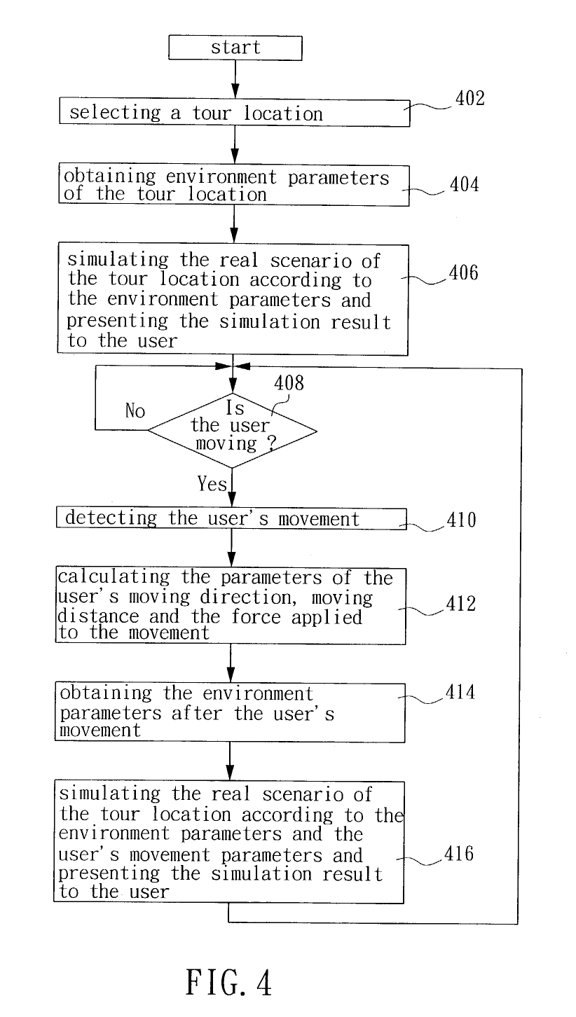

The display device 304 and the audio device 306 in the interactive real-scene tour simulation system could be built up with any kind of multimedia device or system, and the air conditioning device 310 and the controlled light source 312 can be any common and available device or system. For example, the display device 304 could be a cathode-ray-tube (CRT) display system, a liquid crystal display (LCD) system or a plasma display system. Large size display screen and large size activity platform could be used to create better simulation effect, and numerous screens installed at different angles will also generate excellent simulation scene. Besides, the audio system could be a general twin-channel panning audio device, a hi-fi stereo system or a home theater 5.1D audio system. The air conditioning device 310 and the controlled light source 312 could be any available device or system in the market. The control unit 308 can be built with any Application Specific Integrated Circuit (ASIC) and embedded in the interactive real-scene tour simulation system to read program code and control the operation of the interactive real-scene tour simulation. The program code (such as the one used to control the operation in FIG. 4) could be stored in the ASIC or a memory (like ROM, EEPROM or Flash) that can be read out by the ASIC. Moreover, the geographic information system or the expert system in the embodiment of the present invention could be embedded directly in the ASIC and could provide the information when the user selects the tour location or provide the real time information via a network (such as Internet or Local Area Network). The input device 314 could be any kind of keyboards such as the keyboard connected directly with the activity system 302 (just like the control keyboard 210 illustrated in FIG. 2) or a separate keyboard, or can be a wireless transfer device (such as a remote controller). The activity system 302 used in the present invention could be any activity system that is able to receive the simulation signal (such as the signal indicating a protruding object or a dent pit) from the control unit 308, without departing from the scope and the spirit of the present invention.

Next, referring now to FIG. 4 which illustrates an operational flow of the interactive real-scene tour simulation system in the preferred embodiments of the present invention.

When an user employs the interactive real-scene tour simulation system to take a tour, he could select a tour location (step 402) on the geographic information system (or a expert system) provided by the interactive real-scene tour simulation system. Next, in step 404, the interactive real-scene tour simulation system will obtain the environment parameters of the terrain, the atmospheric temperature, the wind speed and the sound effect of the tour location and, in step 406, simulate the terrain, the atmospheric temperature, the sunshine intensity, the environment sound effect associated with the tour location according to the parameter obtained, and present the result to the user. When the user starts moving (step 408), the interactive real-scene tour simulation system of the present invention will immediately detect the user's movement parameters (step 410), and the methods used for detection are as described in FIG. 6A and FIG. 6B. Otherwise, the interactive real-scene tour simulation system of the present invention will standby and wait for the user's movement. The interactive real-scene tour simulation system of the present invention will then further calculate the movement parameters of the moving direction, the moving distance and the moving force (step 412), and will obtain the environment parameters according to the movement parameters (step 414). Finally, in step 416, the interactive real-scene tour simulation system of the present invention simulates the terrain, the atmospheric temperature, the wind speed, the sunshine intensity and the environment sound effect associated with the tour location according to the changes of the environment parameters in real-rime and presents the simulation result to the user via the activity system 302, the display device 304, the audio device 306, the air conditioning device 310 and the controlled light source 312. More importantly, in step 402, the interactive real-scene tour simulation system of the present invention provides a function for the user to select the parameters of the pace and timeframe of the tour. And, when the user change the traveling speed and the moving direction, the interactive real-scene tour simulation system of the present invention will immediately change the environmental scenario accordingly, while the possible modification can be made without departing from scope and the spirit of the present invention.

As a conclusion, the interactive real-scene tour simulation system disclosed in the present invention provides the user the system and method with which the user could select a tour location via tour location display system. After the user selects the tour location, the system and the method will obtain the environment parameters associated with the selected tour location and simulate the terrain, the atmospheric temperature, the sunshine intensity and the environment sound effect according to the environment parameters, and the simulation result will be further presented to the user. When the user starts moving, the interactive real-scene tour simulation system of the present invention will detect the user's movement parameter immediately. The interactive real-scene tour simulation system of the present invention will further calculate the movement parameters of the moving direction, the moving distance and the moving force, and will obtain the environment parameters according to the movement parameters. Finally, the interactive real-scene tour simulation system of the present invention simulates the environment scenario according to the environment parameters and presents the simulation result to the user in real-time to fulfill the interactive aspect of the present invention.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is;

1. An interactive real-scene tour simulation system that simulates real scenes interiorly to make an user feel like taking a real outdoor tour while performing an indoor activity, said interactive real-scene tour simulation system comprises:
a tour location display system for providing tour locations for said user to select from, wherein said user can select a tour location from said tour location display system to proceed a tour;
an input device with which said user inputs said tour location of selection;
an environment simulation system for generating an environment-like simulation effect to present to said user;
an activity system with which said user can perform activities on, and is responding to said activities performed by said user, thus generating a set of tour activity parameters; and
a control unit responding to said set of tour activity parameters and environment parameters of said tour location of selection to generate a tour simulation result which simulates said user taking a real tour at said tour location, and outputs said simulation result to said environment simulation system as well as back to said activity system for presenting to said user.

2. The interactive real-scene tour simulation system according to claim 1, wherein said tour location display system is a geographic information system (GIS).

3. The interactive real-scene tour simulation system according to claim 1, wherein said tour location display system is an expert system.

4. The interactive real-scene tour simulation system according to claim 1, wherein said environment simulation system comprises at least one of the followings: a display device; an audio device; an air conditioning device; and a light source, for presenting said tour simulation result of said tour location to said user.

5. The interactive real-scene tour simulation system according to claim 4, wherein said display device is selected from the group consisting of cathode ray tube (CRT) display system, liquid crystal display (LCD) system and plasma display system.

6. The interactive real-scene tour simulation system according to claim 4, wherein said audio device is selected from the group consisting of twin-channel panning sound system, hi-fi stereo system and home theater 5.1D sound system.

7. The interactive real-scene tour simulation system according to claim 1, wherein said activity system is responding to said tour simulation result of said tour location, and thus presenting a terrain simulation result of said tour location to said user.

8. The interactive real-scene tour simulation system according to claim 1, wherein said activity system comprises at least one of the followings: an exercise equipment system and a video game system.

9. The interactive real-scene tour simulation system according to claim 1, wherein said set of tour activity parameters comprises at least one of the following parameters: said user's moving direction, moving distance and force applied to make an move.

10. The interactive real-scene tour simulation system according to claim 1, wherein said tour simulation result includes at least one of the following simulation results associated with said tour location: terrain; atmospheric temperature; sunshine intensity; and environmental sound effect.

11. An interactive real-scene simulation method that simulates real scenes interiorly to make an user feel like taking a real outdoor tour while having an indoor activity, said interactive real-scene simulation method comprises the following steps:
selecting a tour location on a tour location display system;
obtaining environment parameters of said tour location;
detecting a movement from said user;
calculating movement parameters based on said movement;
generating a tour simulation result that simulates said user taking a tour at said tour location according to said movement parameters and said environment parameters; and
presenting said tour simulation result to said user.

12. The interactive real-scene tour simulation method according to claim 11 further comprises obtaining said environment parameters in real-time after the step of calculating said movement parameters.

13. The interactive real-scene tour simulation method according to claim 12 further comprises repeating the step of detecting said movement to the step of presenting said tour simulation result till the tour ends.

14. The interactive real-scene tour simulation method according to claim 11, wherein said movement parameters include at least one of the followings: a moving direction, a moving distance and a force applied to said movement by said user.

15. The interactive real-scene tour simulation method according to claim 11, wherein said tour location display system is selected from the group consisting of geographic information system (GIS) and expert system.

16. The interactive real-scene tour simulation method according to claim 11, wherein said tour simulation result is presented to said user via an environment simulation system.

17. The interactive real-scene tour simulation method according to claim 16, wherein said environment simulation system comprises at least one of the followings: a display device; an audio device; an air conditioning device; and a light source.

18. The interactive real-scene tour simulation method according to claim 17, wherein said display device is selected from the group consisting of cathode ray tube (CRT) display system, liquid crystal display (LCD) system and plasma display system.

19. The interactive real-scene tour simulation method according to claim 17, wherein said audio device is selected from the group consisting of twin-channel panning sound system, hi-fi stereo system and home theater 5.1D sound system.

20. The interactive real-scene tour simulation method according claim 11, wherein said tour simulation result includes at least one of the following simulation results associated with said tour location: terrain; atmospheric temperature; sunshine intensity; and environmental sound effect.
